(19) United States
(12) Patent Application Publication
(10) Pub. No.: US 2019/0266061 A1
(43) Pub. Date: Aug. 29, 2019

(54) INFORMATION PROCESSING APPARATUS, CONTROL METHOD FOR INFORMATION PROCESSING APPARATUS, AND COMPUTER-READABLE RECORDING MEDIUM HAVING STORED THEREIN CONTROL PROGRAM FOR INFORMATION PROCESSING APPARATUS

(71) Applicant: FUJITSU LIMITED, Kawasaki-shi (JP)

(72) Inventors: Go Endo, Kawasaki (JP); Koji Narihiro, Yokohama (JP)

(73) Assignee: FUJITSU LIMITED, Kawasaki-shi (JP)

(21) Appl. No.: 16/248,846

(22) Filed: Jan. 16, 2019

(30) Foreign Application Priority Data
Feb. 27, 2018 (JP) 2018-033890

(51) Int. Cl. G06F 11/20; G06F 13/362

(52) U.S. Cl. CPC G06F 11/2007; G06F 2201/805; G06F 13/362

(57) ABSTRACT

An information processing apparatus includes: a main body device that performs information processing; and a plurality of control devices that control the main body device, wherein a first control device that operates as a master that controls the main body device is configured to: determine whether a second control device that operates as a slave that takes over a function of the master when an error occurs in the first control device is normal; and perform a first transfer that transfers a control command used to control the main body device to the second control device when determining that the second control device is normal, and the second control device is configured to: receive the control command which is transferred by the first transfer unit; and perform a second transfer that transfers the control command which is received to the main body device.

### CROSS-REFERENCE TO RELATED APPLICATION

This application is based upon and claims the benefit of priority of the prior Japanese Patent Application No. 2018-33890, filed on Feb. 27, 2018, the entire contents of which are incorporated herein by reference.

### FIELD

The embodiments discussed herein are related to an information processing apparatus, a control method for the information processing apparatus, and a control program for the information processing apparatus.

### BACKGROUND

A server (information processing apparatus) that performs information processing has a service processor (SVP) that controls, for example, initialization of a main body, in addition to the main body that performs information processing.

Related art is disclosed in International Publication Pamphlet No. WO 2008/111137 and International Publication Pamphlet No. WO 2012/023200.

### SUMMARY

According to an aspect of the embodiments, an information processing apparatus includes: a main body device that performs information processing; and a plurality of control devices that control the main body device, wherein a first control device that operates as a master that controls the main body device is configured to: determine whether a second control device that operates as a slave that takes over a function of the master when an error occurs in the first control device is normal; and perform a first transfer that transfers a control command used to control the main body device to the second control device when determining that the second control device is normal, and the second control device is configured to: receive the control command which is transferred by the first transfer unit; and perform a second transfer that transfers the control command which is received to the main body device.

The object and advantages of the invention will be realized and attained by means of the elements and combinations particularly pointed out in the claims.

It is to be understood that both the foregoing general description and the following detailed description are exemplary and explanatory and are not restrictive of the invention.

According to one aspect, the present invention may restrain re-execution of a control command not re-executable at the time of SVP switching and restrain server administration from being stopped.

### BRIEF DESCRIPTION OF DRAWINGS

FIG. 1 is a diagram illustrating a hardware configuration of a server according to an embodiment;

FIG. 2 is a diagram illustrating a functional configuration of control programs;

FIG. 3 is a diagram for explaining a flow of execution of a control command;

FIG. 4 is a diagram for explaining features of a kernel layer;

FIG. 5 is a diagram illustrating a flow of a control command during normal administration;

FIG. 6 is a sequence diagram illustrating a flow of execution of a control command during normal administration;

FIG. 7 is a diagram illustrating an example of a data structure of a packet used for transfer of a macro number;

FIG. 8 is a diagram illustrating an example of a data structure of a control command packet to be transferred by direct memory access (DMA);

FIG. 9 is a diagram illustrating factors of interrupt to a CPU;

FIG. 10 is a diagram illustrating a flow of a control command at the time of master failure;

FIG. 11 is a sequence diagram illustrating a flow of execution of a control command at the time of master failure;

FIG. 12 is a diagram illustrating a flow of a control command at the time of slave failure;

FIG. 13 is a sequence diagram illustrating a flow of execution of a control command at the time of slave failure;

FIG. 14 is a diagram illustrating registers included in a complex programmable logic device (CPLD);

FIG. 15 is a diagram illustrating a hardware configuration of a server;

FIG. 16 is a diagram illustrating a functional configuration of control programs;

FIG. 17 is a diagram illustrating a flow up to hardware macro execution;

FIG. 18 is a diagram for explaining synchronization by a macro number; and

FIG. 19 is a diagram for explaining a problem occurring in synchronization by the macro number.

### DESCRIPTION OF EMBODIMENTS

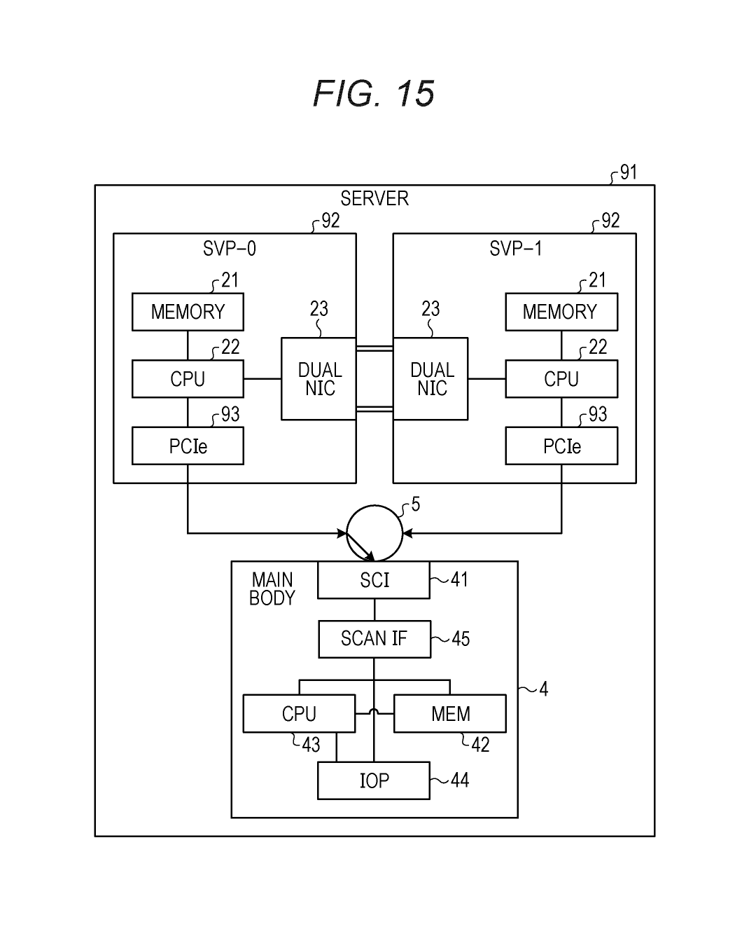

FIG. 15 is a diagram illustrating the hardware configuration of the server. As illustrated in FIG. 15, a server 91 has SVPs 92 represented by SVP-0 and SVP-1, a main body 4, and a switch 5.

The SVPs 92 are redundant and, for example, the SVP-0 operates as a master during normal administration and the SVP-1 operates as a slave when the master fails. Each SVP 92 has a memory 21, a central processing unit (CPU) 22, a dual network interface card (NIC) 23, and a peripheral component interconnect express (PCIe) 93.

The memory 21 is a nonvolatile storage device that stores a control program for controlling the main body 4. The CPU 22 is a central processing unit that reads out the control program from the memory 21 to execute. The dual NIC 23 is a communication device used for duplex communication with another SVP 92. The PCIe 93 is a connecting device that connects the SVP 92 and the main body 4.

In order to switch from the master to the slave, the master and the slave regularly perform alive monitoring using the dual NICs 23 and also the master transfers control information on the main body 4 to the slave to synchronize processing.

The main body 4 has a system control interface (SCI) 41, a MEM 42, a CPU 43, an input output processor (IOP) 44, and a scan interface (IF) 45. The SCI 41 is a controller that receives a control command from the SVP 92 and controls the main body 4. The MEM 42 is a random access memory (RAM) that stores a program to be executed on the main body 4, an intermediate execution result, and the like. The CPU 43 is a central processing unit that reads out a program from the MEM 42 to execute.

The input output processor (IOP) 44 is a processor that performs input/output control for the main body 4. The scan IF 45 is a device that executes the control command received by the SCI 41. The scan IF 45 is, for example, an inter-integrated circuit (I2C) or a JTAG (a device based on the joint test action group (JTAG) standard).

The switch 5 switches the SVP 92 coupled to the main body 4 between the SVP-0 and the SVP-1. FIG. 15 illustrates a case where the SVP-0 is coupled to the main body 4.

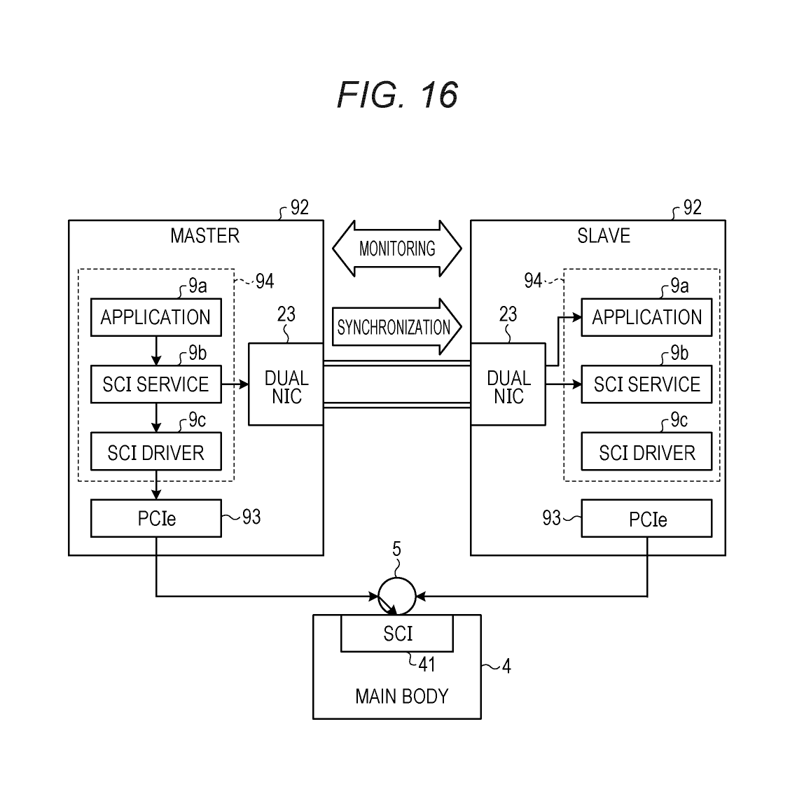

FIG. 16 is a diagram illustrating the functional configuration of the control programs. As illustrated in FIG. 16, a control program 94 includes an application 9a, an SCI service 9b, and an SCI driver 9c. The application 9a is an application for controlling the main body 4. The SCI service 9b is an application that manages SCI control for communicating with the SCI 41. The SCI driver 9c is a driver that performs SCI control. The application 9a and the SCI service 9b operate on an application layer, while the SCI driver 9c operates on a kernel layer.

The SCI service 9b communicates with the other SVP 92 using the dual NIC 23 to monitor each other. In a case where the master fails, the control program 94 of the slave detects a failure by alive monitoring when communication with the control program 94 of the master is broken, and performs control of the main body 4 on behalf of the control program 94 of the master. In addition, the SCI service 9b of the master transfers the control information on the main body 4 to the SCI service 9b of the slave to synchronize processing.

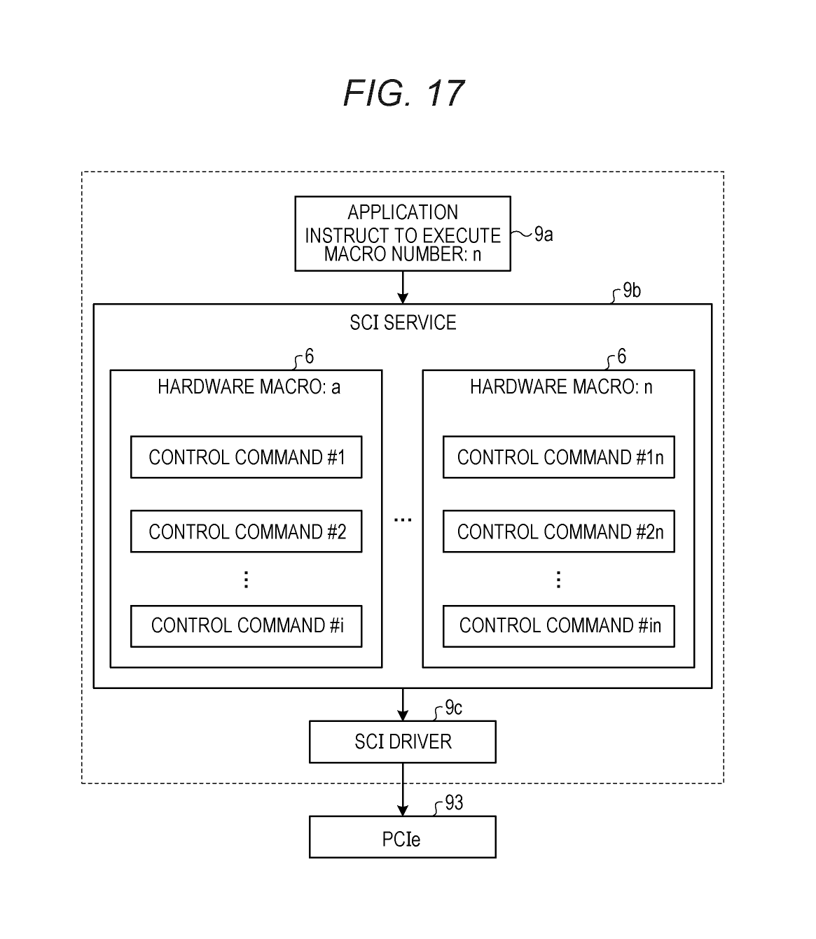

The control program 94 controls the main body 4 by executing a hardware macro in which control commands are collected on a control sequence basis. FIG. 17 is a diagram illustrating a flow up to the execution of the hardware macro. As illustrated in FIG. 17, a macro number is given to a hardware macro 6, and the application 9a instructs to execute the hardware macro 6 with the macro number.

The SCI service 9b designates a control command included in the hardware macro 6 and instructs the SCI driver 9c to execute. In FIG. 17, for example, when execution of a macro with a macro number a is instructed by the application 9a, the SCI service 9b instructs the SCI driver 9c to execute control commands #1 to #i on a control command basis. The SCI driver 9c converts the control command into a PCI packet and transfers the converted PCI packet to the SCI 41 via the PCIe 93.

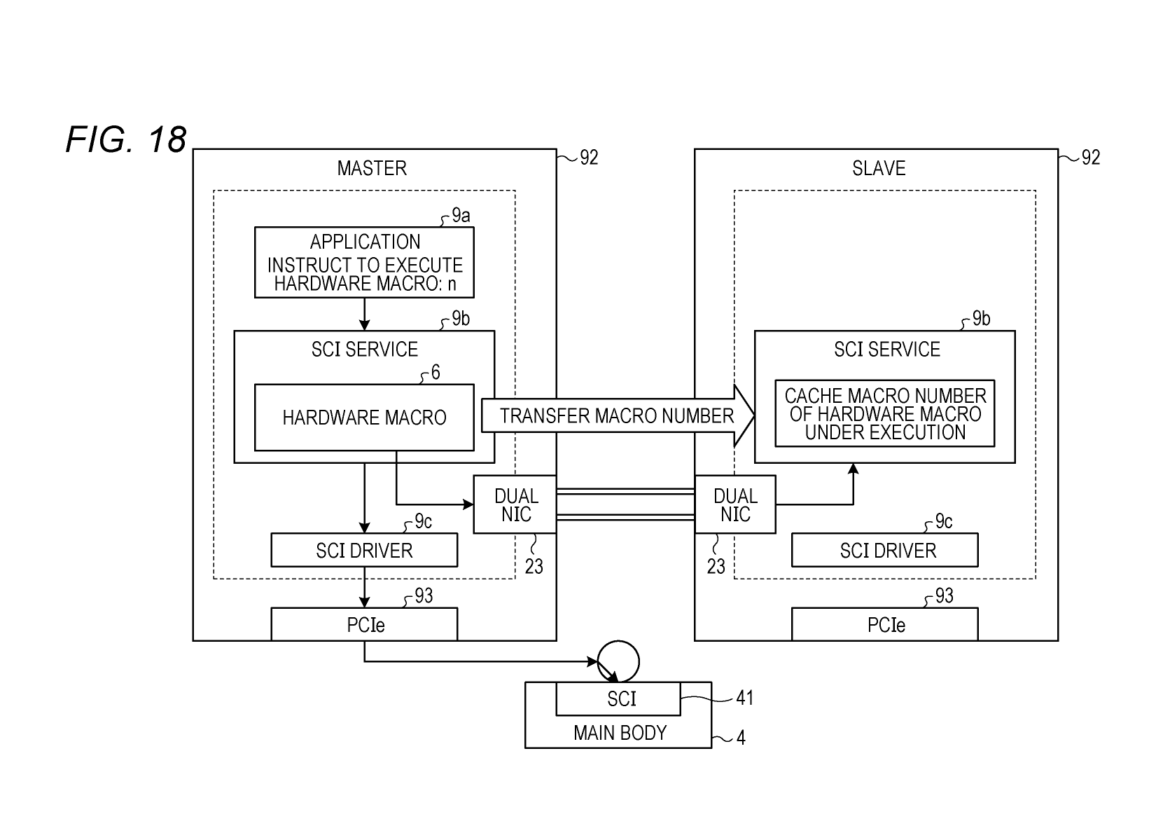

FIG. 18 is a diagram for explaining synchronization by a macro number. As illustrated in FIG. 18, the SCI service 9b of the master transfers the macro number of the hardware macro 6 to be executed to the SCI service 9b of the slave using the dual NIC 23 in case of failure. Upon receiving the macro number, the SCI service 9b of the slave caches the received macro number as the macro number of the hardware macro 6 under execution. When a failure of the master is detected, the SCI service 9b of the slave takes over the control of the main body 4 using the cached macro number.

Incidentally, there is a technology for, when a service processor of an active system performing domain dynamic reconfiguration processing fails during the execution of the domain dynamic reconfiguration processing, switching a service processor of a standby system to the active system such that the domain dynamic reconfiguration processing under execution is taken over to be executed. The domain dynamic reconfiguration mentioned here means dynamically reconfiguring a domain made up of a plurality of system boards.

In addition, there is a technology for causing an information processing apparatus to keep on processing when a management apparatus that manages the execution of processing by the information processing apparatus is changed to another management apparatus. In this technology, the information processing apparatus executes a processing sequence including a plurality of processing steps. The management apparatus manages the execution of the processing sequence by causing the information processing apparatus to execute the processing steps in a predetermined order. When the management apparatus takes over execution management of the processing sequence from another management apparatus, an information acquisition unit of the management apparatus acquires state information indicating the progress state of the processing sequence from the information processing apparatus. A control unit of the management apparatus causes the information processing apparatus to continue executing unexecuted processing steps of the processing sequence on the basis of the state information acquired by the information acquisition unit.

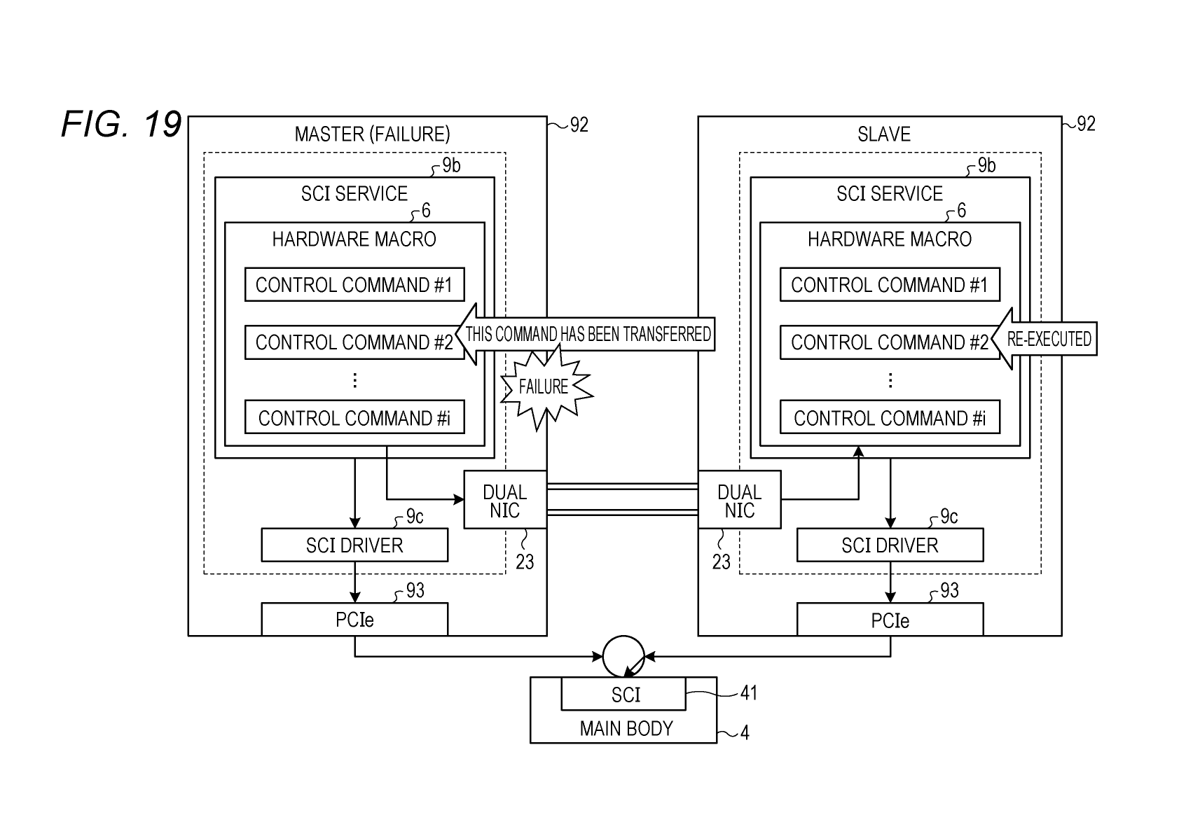

FIG. 19 is a diagram for explaining a problem occurring in synchronization by the macro number. Among the control commands, there is a command for resetting hardware and a command that causes a trouble when re-executed is included. It is assumed that, after executing a control command not re-executable among the hardware macro 6, the master has failed while executing the remaining control command included in the hardware macro 6. Thereafter, since the slave executes the control commands of the hardware macro 6 from the top one using the cached macro number, there is a problem that the control command not re-executable is executed again and it becomes difficult to continue the administration of the server 91.

In FIG. 19, it is assumed that a control command #2 is a control command not re-executable and, if the master fails after the execution of the control command #2, the control command #2 is re-executed by the slave.

According to one aspect of the embodiments, it is an object to restrain re-execution of a control command not re-executable at the time of SVP switching and to restrain server administration from being stopped.

Embodiments of an information processing apparatus, a control method for the information processing apparatus, and a control program for the information processing apparatus disclosed in the present application will be described in detail below with reference to the drawings. Note that these embodiments do not limit the disclosed technology.

### Embodiments

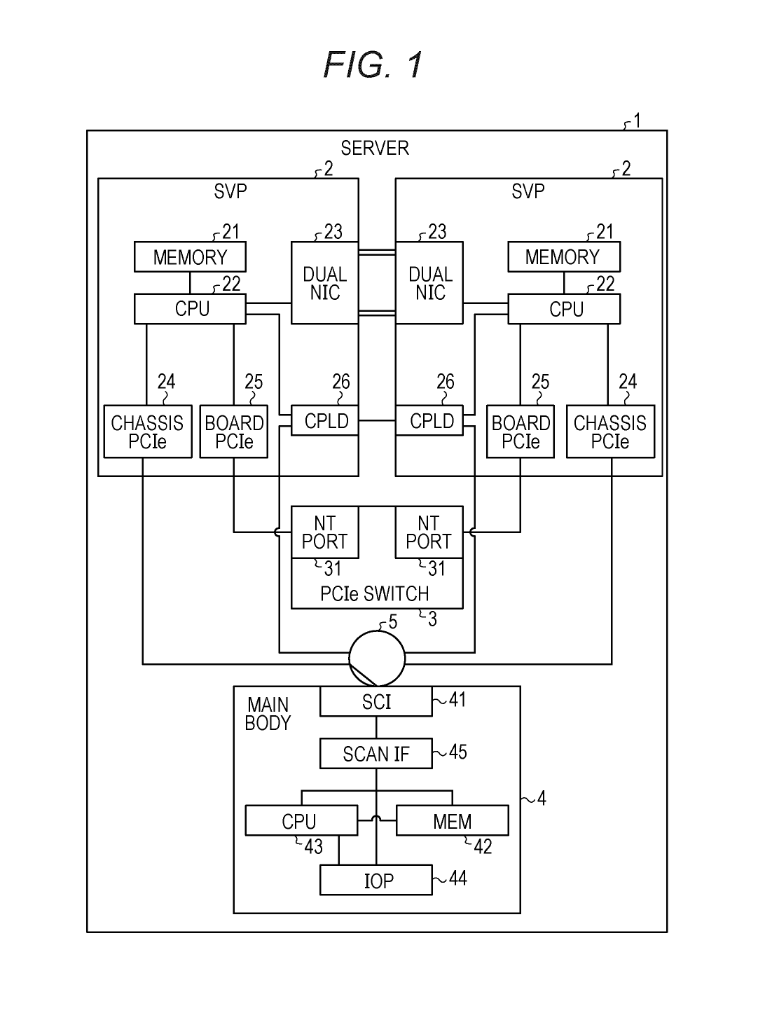

First, the hardware configuration of a server according to an embodiment will be described. FIG. 1 is a diagram illustrating the hardware configuration of the server according to the embodiment. As illustrated in FIG. 1, the server 1 has two SVPs 2, a PCIe switch 3, a main body 4, and a switch 5.

One of the two SVPs 2 operates as a master during normal administration and the other one operates as a slave when the master has failed. Each SVP 2 has a memory 21, a CPU 22, a dual NIC 23, a chassis PCIe 24, a board PCIe 25, and a complex programmable logic device (CPLD) 26.

The memory 21 is a nonvolatile storage device that stores a control program for controlling the main body 4. The CPU 22 is a central processing unit that reads out the control program from the memory 21 to execute. The control program may be read out from a hard disc drive (HDD) to a RAM and read out from the RAM to be executed. Furthermore, the control program may be stored in, for example, a digital versatile disk (DVD) and read out from the DVD to be installed in the SVP 2. Alternatively, the control program may be read out from an HDD of another server coupled through a network to be installed in the SVP 2.

The dual NIC 23 is a communication device used for duplex communication with the other SVP 2. The chassis PCIe 24 makes PCIe connection between the SVP 2 and the main body 4. The board PCIe 25 makes PCIe connection with the board PCIe 25 of the other SVP 2 via the PCIe switch 3. The CPLD 26 manipulates the switch 5 to couple the main body 4 to one of the SVPs 2.

The PCIe switch 3 is a switch for coupling two board PCIes 25. The PCIe switch 3 has two non-transparent (NT) ports 31. One NT port 31 is coupled to one board PCIe 25 and the other NT port 31 is coupled to the other board PCIe 25. Communication via the PCIe switch 3 is faster than communication via the dual NIC 23.

The main body 4 has an SCI 41, a MEM 42, a CPU 43, an IOP 44, and a scan IF 45. The SCI 41 is a controller that receives a control command from the SVP 2 and controls the main body 4. The MEM 42 is a RAM that stores a program to be executed on the main body 4, an intermediate execution result, and the like. The CPU 43 is a central processing unit that reads out a program from the MEM 42 to execute.

The IOP 44 is a processor that performs input/output control of the main body 4. The scan IF 45 is a device that executes the control command received by the SCI 41. The scan IF 45 is, for example, an I2C or a JTAG.

Here, for convenience of explanation, only one MEM 42, CPU 43 and IOP 44 are illustrated, but the main body 4 may have a plurality of MEMs 42, CPUs 43 and IOPs 44.

The switch 5 switches the SVP 2 coupled to the main body 4 between the two SVPs 2. FIG. 1 illustrates a case where the left SVP 2 is coupled to the main body 4.

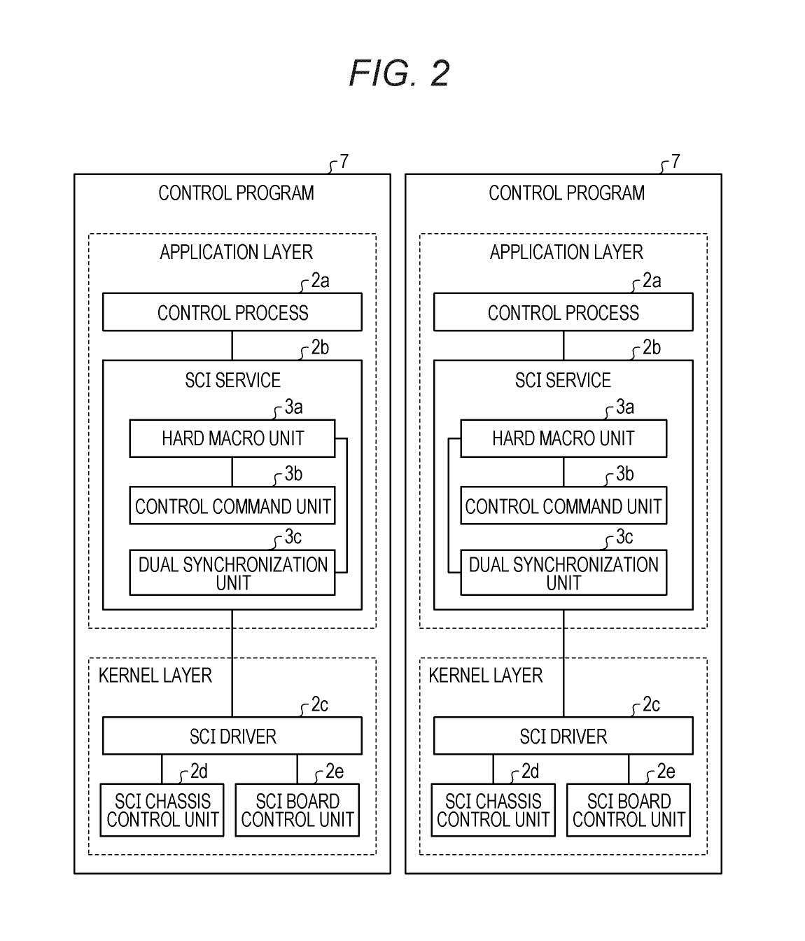

Next, the functional configuration of the control program executed on the SVP 2 will be described. FIG. 2 is a diagram illustrating the functional configuration of control programs. As illustrated in FIG. 2, among modules included in the control program 7, modules executed in an application layer include a control process 2a and an SCI service 2b, while modules executed in a kernel layer include an SCI driver 2c, an SCI chassis control unit 2d, and an SCI board control unit 2e.

The control process 2a is a process of the application 9a, which controls the main body 4. The SCI service 2b is an application that manages SCI control for communicating with the SCI 41. The SCI service 2b has a hard macro unit 3a, a control command unit 3b, and a dual synchronization unit 3c.

The hard macro unit 3a executes the hardware macro 6 designated by the control process 2a. The control command unit 3b passes the control command included in the hardware macro 6 to the SCI driver 2c. The dual synchronization unit 3c communicates with the other SVP 2 using the dual NIC 23.

When operating on the master, the SCI service 2b transfers a macro number of the hardware macro 6 to be executed to the SCI service 2b of the slave using the dual NIC 23 in case of failure. Upon receiving the macro number, the SCI service 2b of the slave caches the received macro number as the macro number of the hardware macro 6 under execution. When the master executing the hardware macro 6 fails, the SCI service 2b of the slave passes a control command subsequent to a control command transferred to the main body 4 by the SCI driver 2c of the slave up to the last control command to the SCI driver 2c in order, on the basis of the cached macro number.

The SCI driver 2c is a driver that performs SCI control. When operating on the master, the SCI driver 2c transfers the control command to the slave when the slave has not failed. The SCI driver 2c uses the SCI board control unit 2e when transferring the control command to the slave. The SCI board control unit 2e transfers the control command to the slave using the board PCIe 25.

When operating on the master, the SCI driver 2c transfers the control command to the main body 4 when the slave has failed. The SCI driver 2c uses the SCI chassis control unit 2d when transferring the control command to the main body 4. The SCI chassis control unit 2d transfers the control command to the SCI 41 using the chassis PCIe 24.

When operating on the slave, the SCI driver 2c accepts the control command from the master via the SCI board control unit 2e and transfers the control command to the main body 4 via the SCI chassis control unit 2d when the master has not failed. The SCI board control unit 2e receives the control command transferred by the master through the board PCIe 25. The SCI chassis control unit 2d accepts the control command transferred from the master through the SCI board control unit 2e via the SCI driver 2c and transfers the accepted control command to the SCI 41 using the chassis PCIe 24.

When operating on the slave, the SCI driver 2c transitions to the master when the master executing the hardware macro 6 fails, and accepts the control command through the SCI service 2b of the own device to transfer the control command to the main body 4 via the SCI chassis control unit 2d.

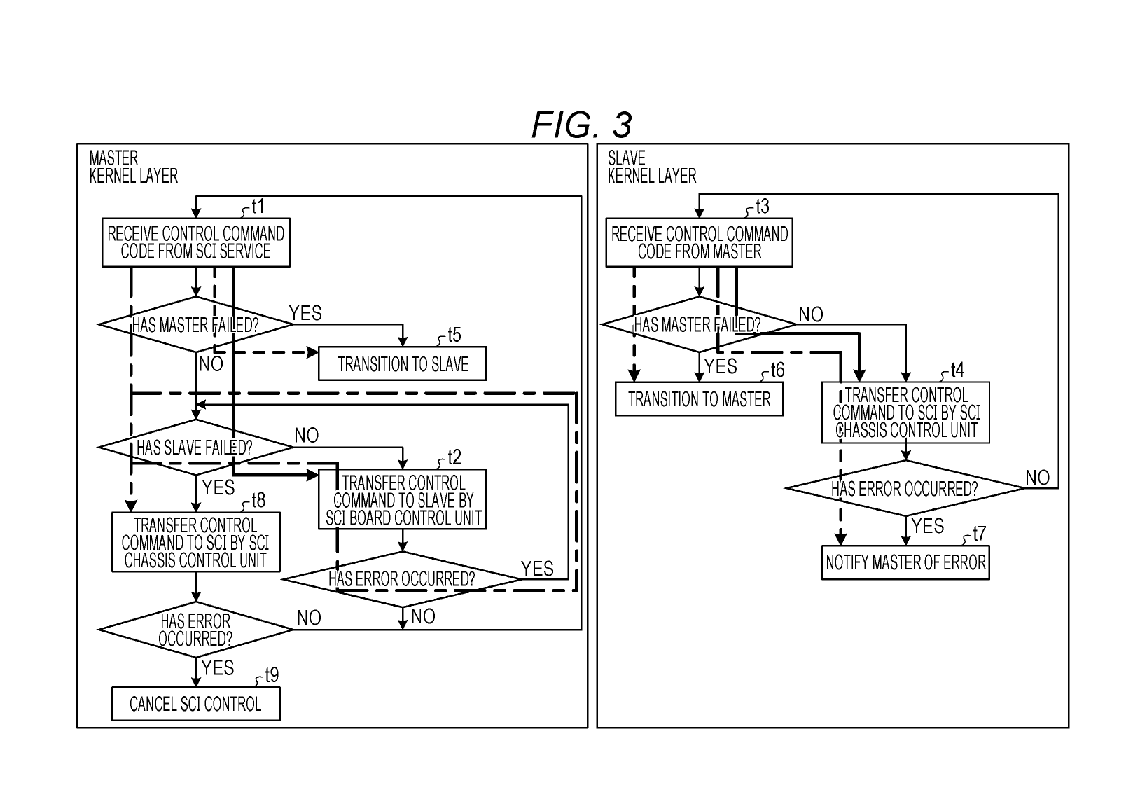

FIG. 3 is a diagram for explaining a flow of execution of the control command. During normal administration when the master and the slave are normal, as indicated by the solid lines, the SCI driver 2c of the master receives a control command code from the SCI service 2b of the master (t1) and transfers the control command to the slave by the SCI board control unit 2e (t2). Here, the control command code is a number that identifies the control command. Then, the slave receives the control command code from the master (t3) and the SCI driver 2c of the slave transfers the control command to the SCI 41 by the SCI chassis control unit 2d (t4).

When the master fails, the master transitions to the slave (t5) and the slave transitions to the master (t6) as indicated by the broken lines. When an error occurs in the slave, the slave notifies the master of the error (t7) as indicated by the one-dot chain lines and the SCI driver 2c of the master transfers the control command to the SCI 41 by the SCI chassis control unit 2d (t8). If an error occurs in the master following the slave, the SCI driver 2c of the master cancels the SCI control (t9).

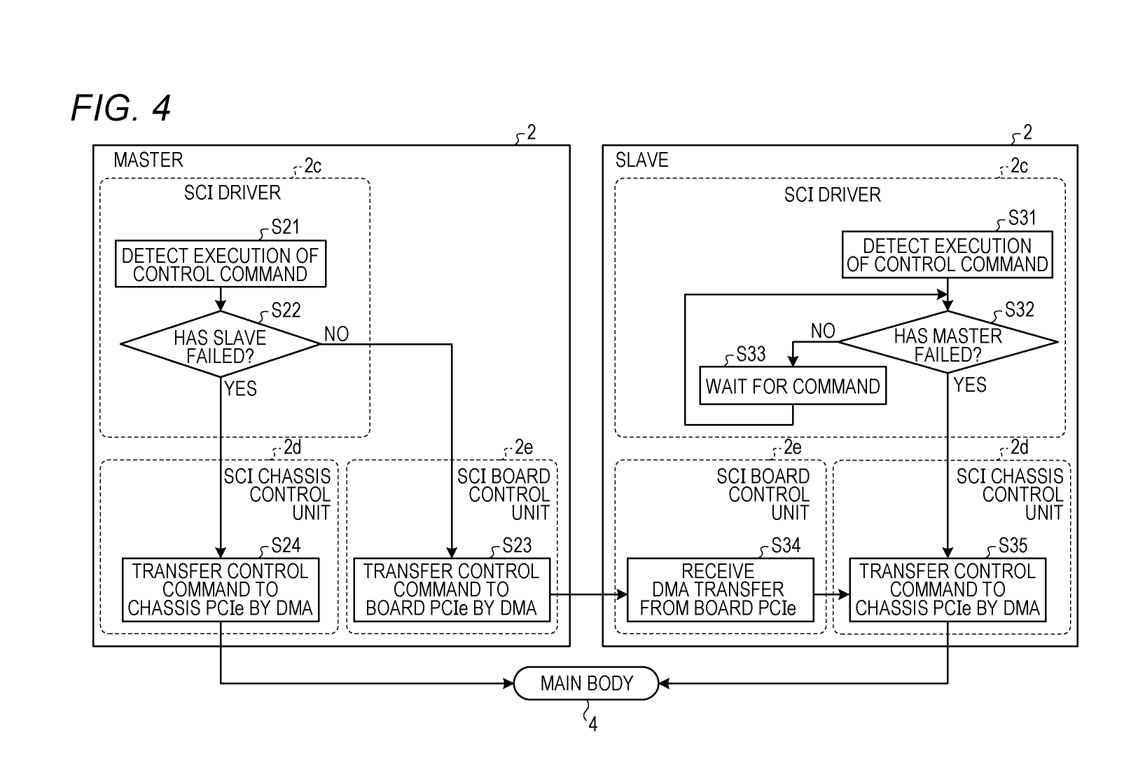

FIG. 4 is a diagram for explaining features of a kernel layer. As illustrated in FIG. 4, in the master, upon detecting execution of the control command (step S21), the SCI driver 2c determines whether the slave has failed (step S22). Then, when the slave has not failed, the SCI board control unit 2e transfers the control command to the board PCIe 25 by direct memory access (DMA) (step S23). On the other hand, if the slave has failed, the SCI chassis control unit 2d transfers the control command to the chassis PCIe 24 by DMA (step S24).

Meanwhile, in the slave, upon detecting execution of the control command (step S31), the SCI driver 2c determines whether the master has failed (step S32). Then, when the master has not failed, the SCI driver 2c waits for a command (step S33) and returns to step S31. On the other hand, if the master has failed, the SCI chassis control unit 2d transfers the control command to the chassis PCIe 24 by DMA (step S35). In addition, upon receiving the DMA transfer from the board PCIe 25 (step S34), the SCI board control unit 2e passes the control command to the SCI chassis control unit 2d via the SCI driver 2c. Then, the SCI chassis control unit 2d transfers the control command to the chassis PCIe 24 by DMA (step S35).

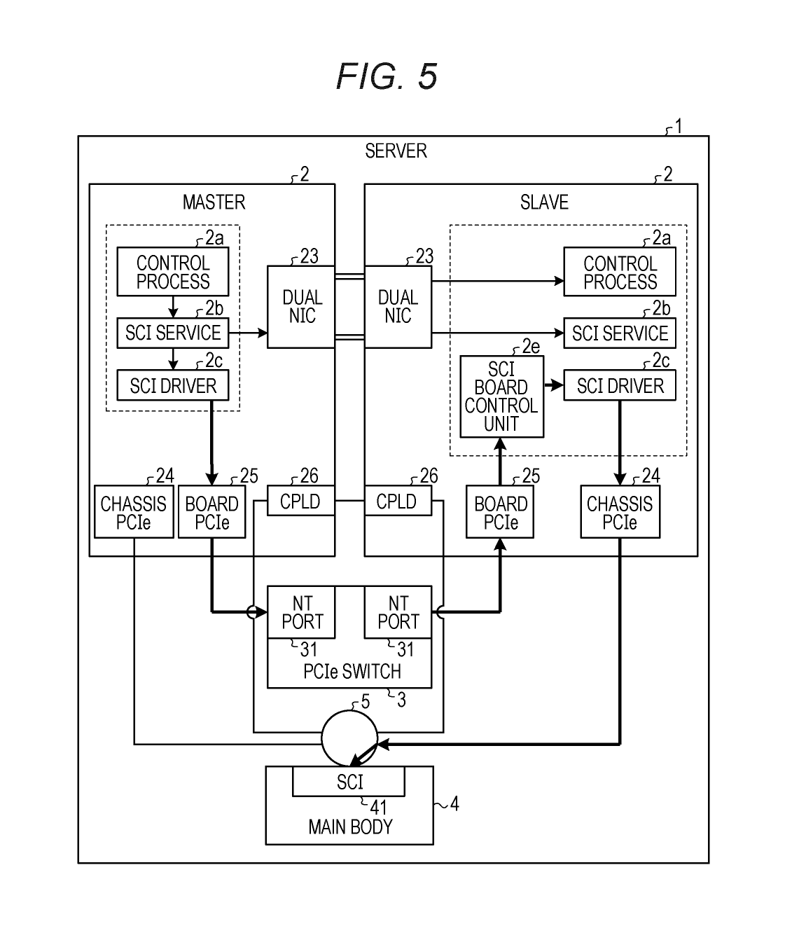

Next, a flow of the control command during normal administration will be described. FIG. 5 is a diagram illustrating a flow of the control command during normal administration. The flow of the control command is indicated by the thick arrows. As illustrated in FIG. 5, the SCI driver 2c of the master passes the control command to the board PCIe 25. The board PCIe 25 transfers the control command to the PCIe switch 3. The PCIe switch 3 transfers the control command to the board PCIe 25 of the slave. The board PCIe 25 of the slave passes the control command to the SCI board control unit 2e. The SCI board control unit 2e passes the control command to the SCI driver 2c. The SCI driver 2c passes the control command to the chassis PCIe 24. The chassis PCIe 24 transfers the control command to the SCI 41.

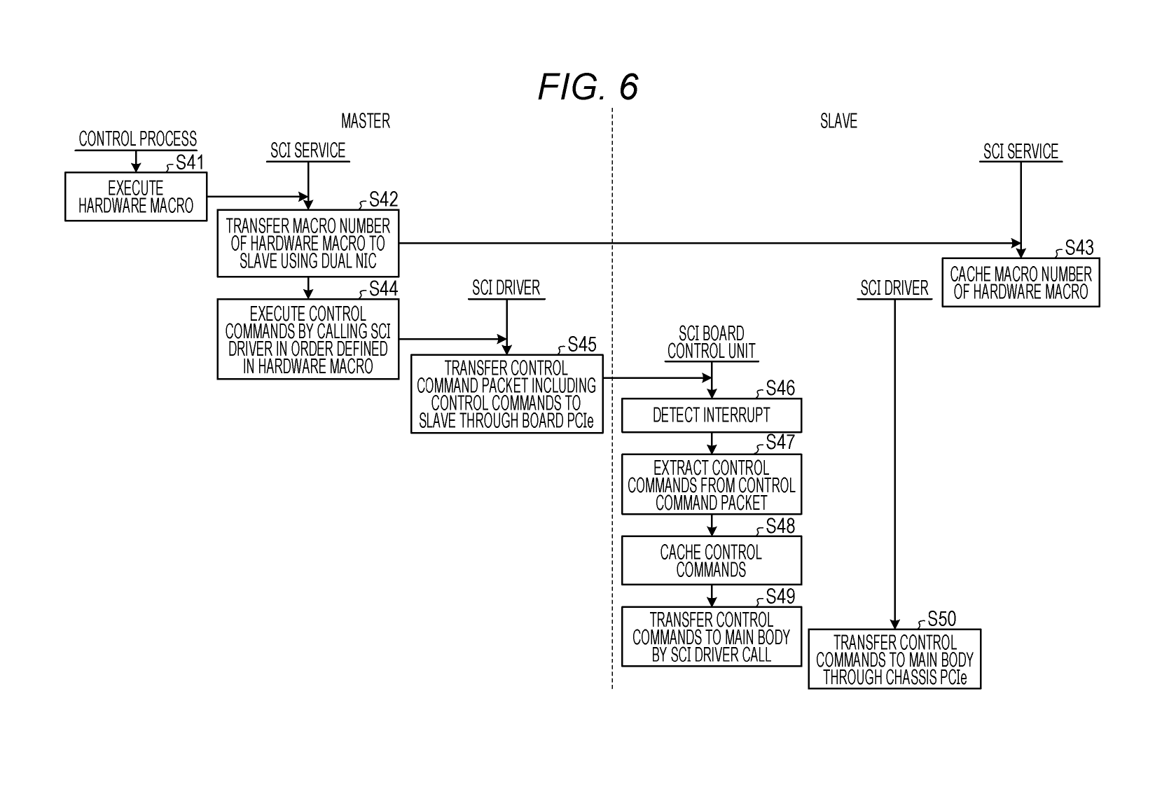

FIG. 6 is a sequence diagram illustrating a flow of execution of the control command during normal administration. As illustrated in FIG. 6, the control process 2a of the master executes the hardware macro 6 (step S41). Then, the SCI service 2b of the master transfers the macro number of the hardware macro 6 to the slave using the dual NIC 23 (step S42). The SCI service 2b of the slave caches the macro number of the hardware macro 6 (step S43).

Then, the SCI service 2b of the master executes the control commands by calling the SCI driver 2c in the order defined in the hardware macro 6 (step S44). The SCI driver 2c of the master transfers a control command packet including the control commands to the slave through the board PCIe 25 (step S45).

The SCI board control unit 2e of the slave detects an interrupt by SCI interrupt (step S46) and extracts the control commands from the control command packet (step S47). Then, the SCI board control unit 2e of the slave caches the control commands (step S48) and transfers the control commands to the main body 4 by an SCI driver call (step S49). The SCI driver 2c of the slave transfers the control commands to the main body 4 through the chassis PCIe 24 (step S50).

In this manner, during normal administration, the SCI driver 2c of the master transfers the control command to the slave such that the SCI driver 2c of the slave transfers the control command to the main body 4. Therefore, when the master has failed, the slave may specify the control command to be transferred to the main body 4 next and restrain re-execution of a control command not re-executable.

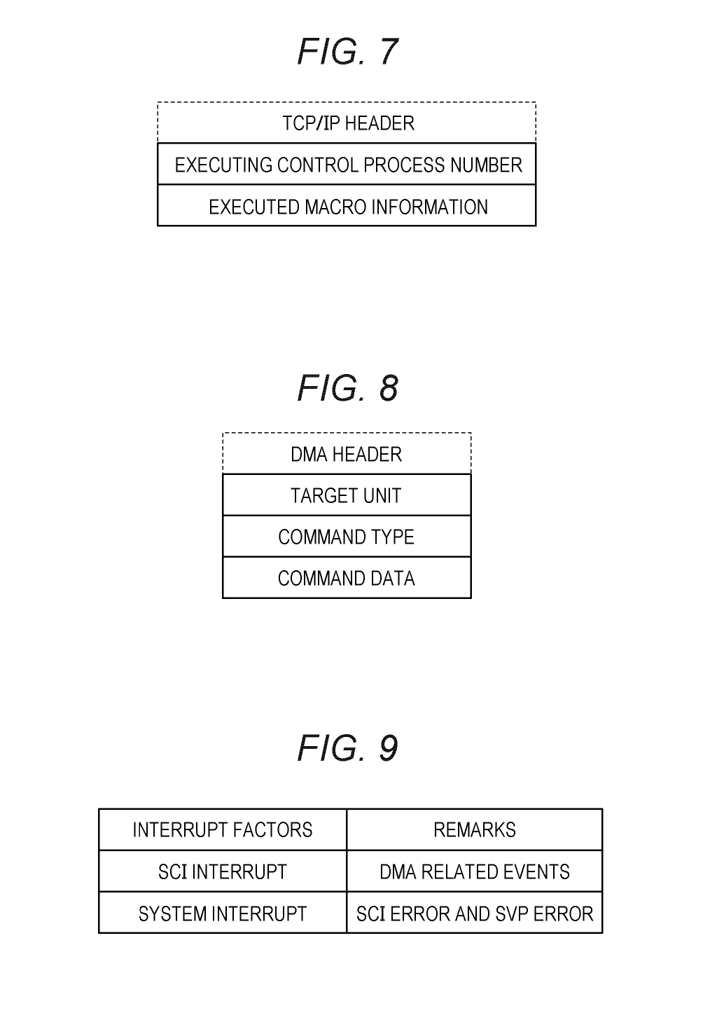

FIG. 7 is a diagram illustrating an example of the data structure of a packet used for transfer of the macro number. As illustrated in FIG. 7, the packet includes a transmission control protocol (TCP)/Internet protocol (IP) header, an executing control process number, and executed macro information. The executing control process number is the number of the control process 2a that executes the hardware macro 6. There are cases where a plurality of control processes 2a are simultaneously executed and the slave specifies the control process 2a using the executing control process number. The executed macro information is the macro number and macro parameter information of the hardware macro 6.

FIG. 8 is a diagram illustrating an example of the data structure of the control command packet to be transferred by DMA. As illustrated in FIG. 8, the control command packet to be transferred by DMA includes a DMA header, a target unit, a command type, and command data. The target unit is a code that identifies a unit for which the control command is to be executed. The command type is a code that identifies the control command and identifies whether the control command is an I2C command or a JTAG command. The command data is data of the control command.

FIG. 9 is a diagram illustrating factors of interrupts to the CPU 22. As illustrated in FIG. 9, there are an SCI interrupt and a system interrupt as interrupt factors. The SCI interrupt is an interrupt indicating completion of DMA related events. The system interrupt is an interrupt indicating an SCI error or an SVP error.

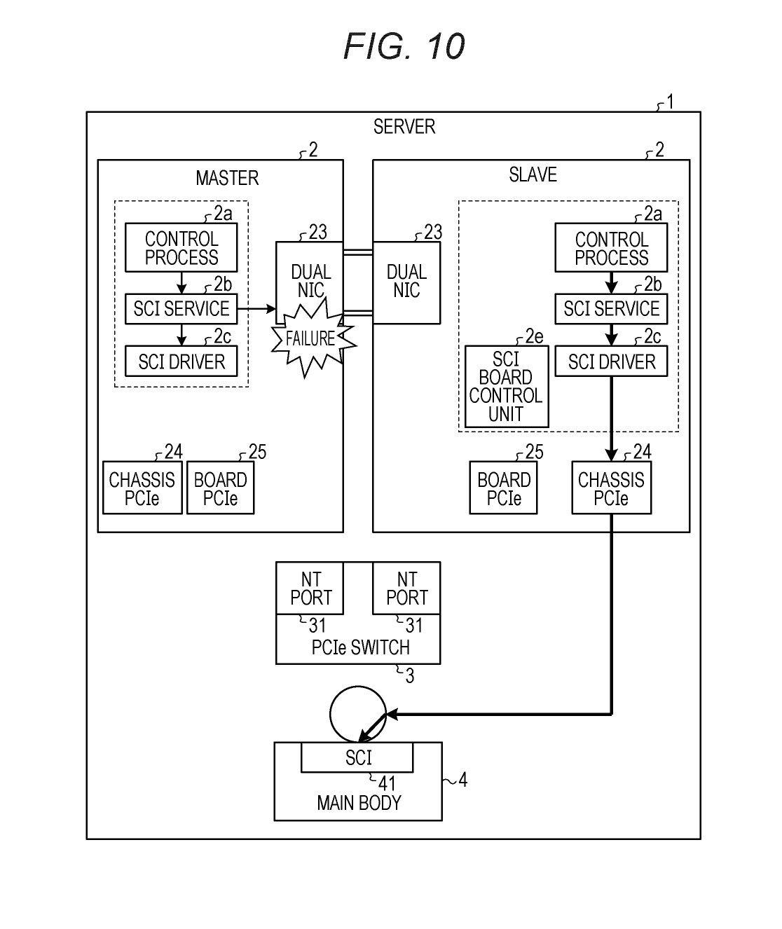

Next, a flow of the control command at the time of master failure will be described. FIG. 10 is a diagram illustrating a flow of the control command at the time of master failure. As illustrated in FIG. 10, the control process 2a of the slave instructs the SCI service 2b to execute the hardware macro 6. The SCI service 2b passes the control commands included in the instructed hardware macro 6 to the SCI driver 2c in order from the top one. The SCI driver 2c passes the control commands to the chassis PCIe 24. The chassis PCIe 24 transfers the control commands to the SCI 41.

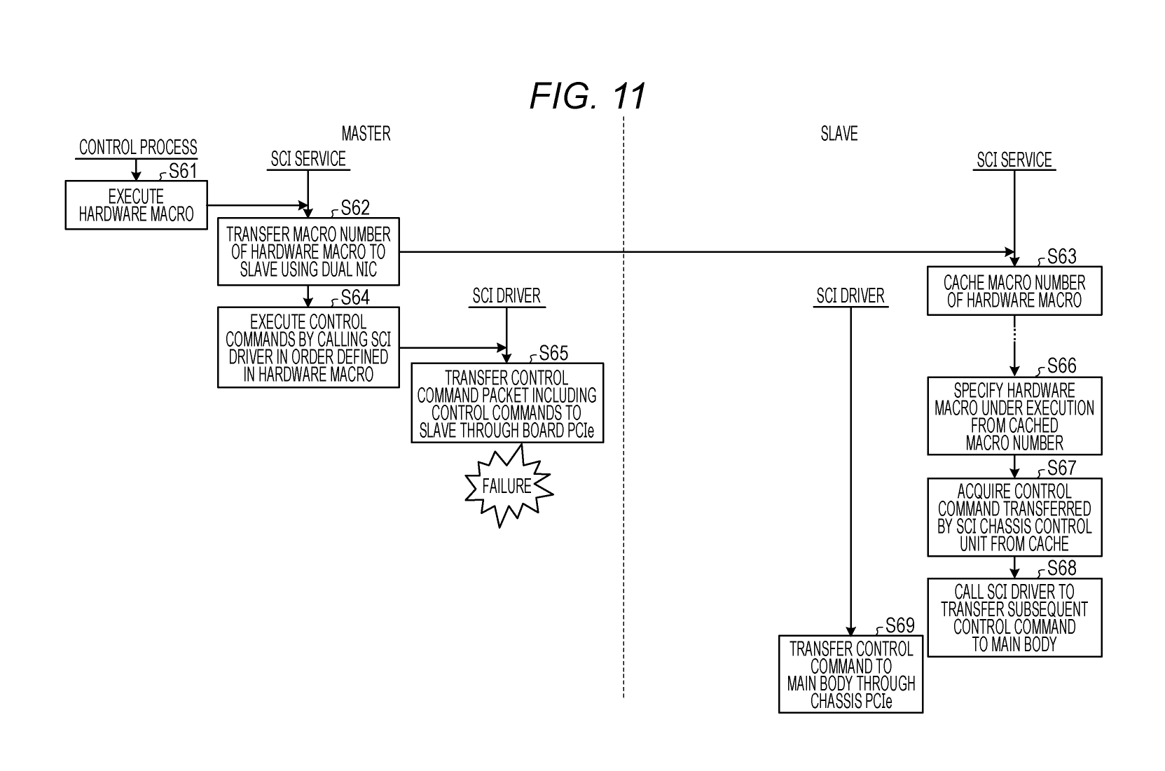

FIG. 11 is a sequence diagram illustrating a flow of execution of the control command at the time of master failure. FIG. 11 illustrates a case where the master fails during hardware macro execution. As illustrated in FIG. 11, the control process 2a of the master executes the hardware macro 6 (step S61). Then, the SCI service 2b of the master transfers the macro number of the hardware macro 6 to the slave using the dual NIC 23 (step S62). The SCI service 2b of the slave caches the macro number of the hardware macro 6 (step S63).

Then, the SCI service 2b of the master executes the control commands by calling the SCI driver 2c in the order defined in the hardware macro 6 (step S64). The SCI driver 2c of the master transfers a control command packet including the control commands to the slave through the board PCIe 25 (step S65). Then, while repeating steps S64 and S65, the master fails.

Thereafter, the slave detects a failure of the master. The slave detects a failure of the master by alive monitoring using the dual NIC 23. Alternatively, the slave detects a failure of the master due to the fact that the next control command is not transferred, there is no response to the execution completion notification for the control command, or the like.

Once a failure of the master is detected, the SCI service 2b of the slave specifies the hardware macro 6 under execution from the cached macro number (step S66). Then, the SCI service 2b of the slave acquires the control command transferred by the SCI chassis control unit 2d from a cache (step S67) and calls the SCI driver 2c to transfer a control command subsequent to the acquired control command to the main body 4 (step S68). The called SCI driver 2c transfers the control command to the main body 4 through the chassis PCIe 24 (step S69).

In this manner, when the master fails, the SCI service 2b of the slave acquires the control command accepted from the SCI board control unit 2e from the cache and transfers the control commands to the main body 4 starting from a control command subsequent to the acquired control command. Therefore, the slave may restrain re-execution of a control command not re-executable.

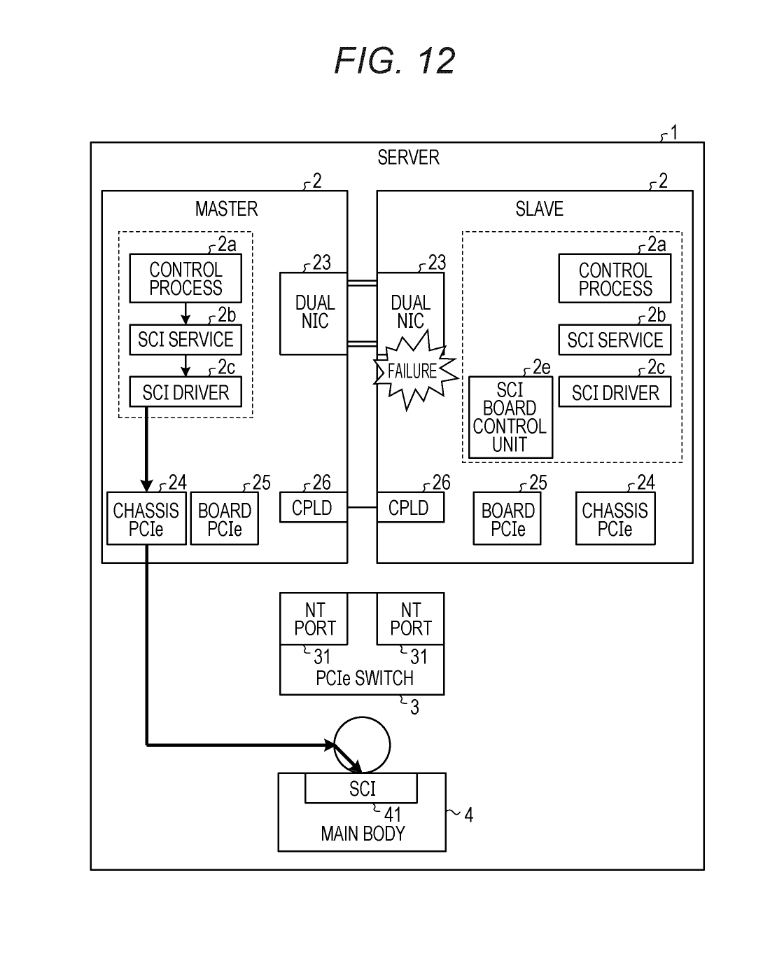

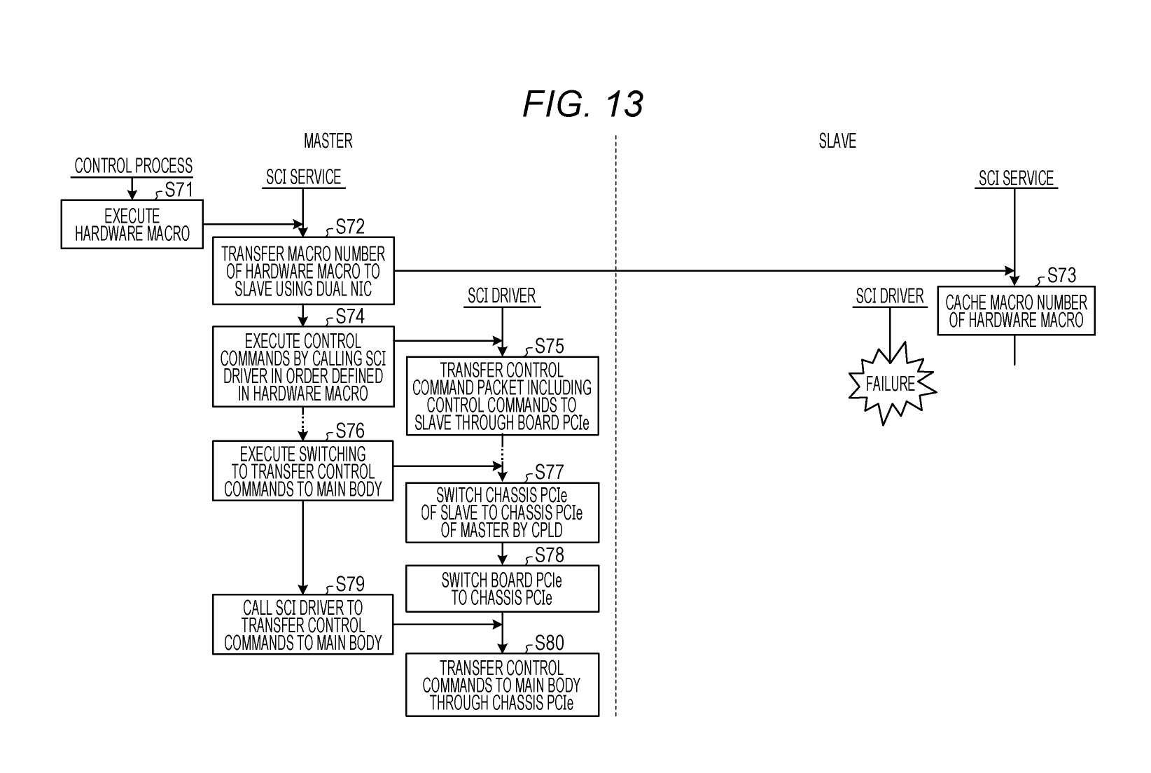

Next, a flow of the control command at the time of slave failure will be described. FIG. 12 is a diagram illustrating a flow of the control command at the time of slave failure. As illustrated in FIG. 12, the SCI driver 2c of the master passes the control command to the chassis PCIe 24. The chassis PCIe 24 transfers the control command to the SCI 41.

FIG. 13 is a sequence diagram illustrating a flow of execution of the control command at the time of slave failure. FIG. 13 illustrates a case where the slave fails while the master is executing the hardware macro. As illustrated in FIG. 13, the control process 2a of the master executes the hardware macro 6 (step S71). Then, the SCI service 2b of the master transfers the macro number of the hardware macro 6 to the slave using the dual NIC 23 (step S72). The SCI service 2b of the slave caches the macro number of the hardware macro 6 (step S73).

Then, the SCI service 2b of the master executes the control commands by calling the SCI driver 2c in the order defined in the hardware macro 6 (step S74). The SCI driver 2c of the master transfers a control command packet including the control commands to the slave through the board PCIe 25 (step S75). Then, while repeating steps S74 and S75, the slave fails.

Thereafter, the master detects a failure of the slave. The master detects a failure of the slave by alive monitoring using the dual NIC 23. Alternatively, the master detects a failure of the slave due to lack of the execution completion notification for the control command, or the like.

Once a failure of the slave is detected, the SCI service 2b of the master executes switching to transfer the control commands to the main body 4 (step S76). Thereafter, the SCI driver 2c of the master switches the chassis PCIe 24 of the slave to the chassis PCIe 24 of the master by the CPLD 26 (step S77). Then, the SCI driver 2c of the master switches the board PCIe 25 to the chassis PCIe 24 (step S78).

Subsequently, the SCI service 2b of the master calls the SCI driver 2c to transfer the control commands to the main body 4 (step S79). Thereafter, the SCI driver 2c of the master transfers the control commands to the main body 4 through the chassis PCIe 24 (step S80).

In this manner, when the slave has failed, the SCI driver 2c of the master transfers the control commands to the main body 4 through the chassis PCIe 24, such that the administration of the server 1 may be continued.

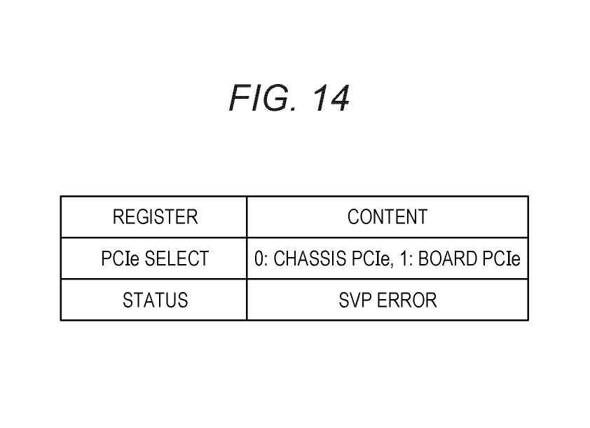

FIG. 14 is a diagram illustrating registers included in the CPLD 26. As illustrated in FIG. 14, the CPLD 26 has a PCI select register and a status register. The PCI select register is used for switching the connection of the switch 5. When the PCI select register is set to 0, the chassis PCIe 24 is selected and the control command is transferred from the master to the main body 4; when the PCI select register is set to 1, the board PCIe 25 is selected and the control command is transferred from the slave to the main body 4. The status register indicates whether the SVP 2 is normal.

As described above, in the embodiment, the SCI driver 2c of the master determines whether the slave is normal and, when the slave is normal, the SCI board control unit 2e of the master transfers the control command to the slave. Then, the SCI board control unit 2e of the slave receives the control command and the SCI chassis control unit 2d transfers the control command to the main body 4. Therefore, when the master has failed, the slave may specify the control command to be transferred to the main body 4 next and restrain a control command not re-executable from being re-executed. Accordingly, the administration of the server 1 may be continued.

Furthermore, in the embodiment, when the slave is not normal, the SCI chassis control unit 2d of the master transfers the control command to the main body 4, such that the main body 4 may be controlled even when the slave has failed.

In the embodiment, when the master has failed, the SCI chassis control unit 2d of the slave transfers the control commands to the main body 4 starting from a control command subsequent to the control command already transferred to the main body 4, such that a control command not re-executable may be restrained from being re-executed.

In the embodiment, the CPLD 26 switches the SVP 2 coupled to the main body 4 between the master and the slave and, in response to the SVP 2 coupled to the main body 4, the SCI driver 2c transfers the control command using the SCI board control unit 2e or the SCI chassis control unit 2d. Therefore, the main body 4 may reliably receive the control command.

In the embodiment, since the SCI board control unit 2e transfers the control command to the slave via the PCIe switch 3, the control command may be transferred at high speed.

Note that the embodiment has described a case where the connection between the main body 4 and one of the two SVPs 2 is switched using the CPLD 26, but the connection may be switched using another device. Furthermore, the embodiment has described a case where communication is performed between the master and the slave using the PCIe, but communication between the master and the slave may be performed using another communication device. The embodiment has described a case where the SCI 41 is used for controlling the main body 4, but the main body 4 may be controlled using another controller.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a main body device that performs information processing; and
a plurality of control devices that control the main body device, wherein
a first control device that operates as a master that controls the main body device is configured to:
determine whether a second control device that operates as a slave that takes over a function of the master when an error occurs in the first control device is normal; and
perform a first transfer that transfers a control command used to control the main body device to the second control device when determining that the second control device is normal, and
the second control device is configured to:
receive the control command which is transferred by the first transfer unit; and
perform a second transfer that transfers the control command which is received to the main body device.

2. The information processing apparatus according to claim 1, wherein
the first control device is further configured to perform a third transfer that transfers the control command to the main body device when determining that the second control device is not normal.

3. The information processing apparatus according to claim 1, wherein
the main body device is controlled by the control command, and
the second control device is configured to transfer a control command succeeding the control command which is transferred to the main body device to the main body device when an error occurs in the first control device.

4. The information processing apparatus according to claim 2, wherein
the first control device is further configured to:
switch connection with the main body device between the first control device and the second control device; and
transfer the control command by the third transfer or the first transfer in response to switching.

5. The information processing apparatus according to claim 1, wherein the control command is transferred to the second control device via a dedicated communication path in the first transfer.

6. A control method for an information processing apparatus including a main body device that performs information processing; and a plurality of control devices that control the main body device, the control method comprising:
determining, by a first control device that operates as a master that controls the main body device, whether a second control device that operates as a slave that takes over a function of the master when an error occurs in the first control device is normal;
transferring, by the first control device, a control command used to control the main body device to the second control device when it is determined that the second control device is normal;
receiving, by the second control device, the control command which is transferred by the first control device; and
transferring, by the second control device, the received control command to the main body device.

7. The control method according to claim 6, further comprising:
performing, by the first control device, a third transfer that transfers the control command to the main body device when determining that the second control device is not normal.

8. The control method according to claim 6, wherein
the main body device is controlled by the control command, and
a control command succeeding the control command which is transferred to the main body device is transferred to the main body device by the second control device when an error occurs in the first control device.

9. The control method according to claim 7, further comprising:
switching, by the first control device, connection with the main body device between the first control device and the second control device; and
transferring the control command by the third transfer or the first transfer in response to switching.

10. The control method according to claim 6, wherein the control command is transferred to the second control device via a dedicated communication path in the first transfer.

11. A non-transitory computer-readable recording medium having stored therein a control program for an information processing apparatus executed in each of a plurality of control devices that control the main body device that performs information processing,
the control program for causing a computer included in a first control device that operates as a master that controls the main body device, to execute a process comprising:
determining whether a second control device that operates as a slave that takes over a function of the master when an error occurs in the first control device is normal; and
transferring a control command used to control the main body device to the second control device when it is determined that the second control device is normal,
the control program for causing a computer included in the second control device to execute a process comprising:
receiving the control command which is transferred by the first control device; and
transferring the received control command to the main body device.

12. The non-transitory computer-readable recording medium according to claim 11, further comprising:
performing, by the first control device, a third transfer that transfers the control command to the main body device when determining that the second control device is not normal.

13. The non-transitory computer-readable recording medium according to claim 11, wherein
the main body device is controlled by the control command, and
a control command succeeding the control command which is transferred to the main body device is transferred to the main body device by the second control device when an error occurs in the first control device.

14. The non-transitory computer-readable recording medium according to claim 12, further comprising:
switching, by the first control device, connection with the main body device between the first control device and the second control device; and
transferring the control command by the third transfer or the first transfer in response to switching.

15. The non-transitory computer-readable recording medium according to claim 6, wherein the control command is transferred to the second control device via a dedicated communication path in the first transfer.
